(19) United States
(12) Patent Application Publication
(10) Pub. No.: US 2005/0210066 A1
(43) Pub. Date: Sep. 22, 2005

(54) Internet-based clearinghouse service for freight services

(76) Inventor: Marco Flavio Ianniello, Trier (DE)

Correspondence Address: Marco Flavio lanniello, SAARSTRASSE 50, TRIER, 54290, DE

(21) Appl. No.: 10/802,120

(22) Filed: Mar. 17, 2004

(51) Int. Cl. G06F 17/30

(52) U.S. Cl. 707/104.1

(57) ABSTRACT

A method for the advertising of freight service between service providers and customers is implemented via a computer network. Through an internet web site interface an individual (carrier, enterprise, etc.), who is in possession of a freight vehicle can post a request for a quotation, which includes all requirements (e.g. routes, time schedule). Another individual (manufacturing company, private person, etc.), who is looking for a freight service can post a request for a quotation, which includes all requirements (e.g. schedule data of the departure and destination locations of the goods). The service provides only the opportunity to find each other. It does not offer any guarantee for service provided and does not establish any contracts. The administrator is neither involved in the contracting procedure nor is aware of any contract concluded. The two parties will be able to contact each other at the addresses specified in their respective announcements.

### DESCRIPTION

1. This invention generally describes an internet-based freight advertising system, which increases the efficiency of delivery, due to the price transparency for all parties and due to the opportunity to fill up empty transport vehicles on their return trips.
2. The claim considers the fact that many transportation conveyances (e.g. trucks, ships, airlines and trains) return empty to their departure points. A coordinating platform can connect through the worldwide internet all parties requiring or offering freight service. This patent covers the application of such a system.
3. On the one hand, parties, who are looking for transportation from a certain location to a certain destination can use this program to enter all freight data. The program generates a list of contacts with all prospective business associates by comparing a request with all offers entered from freight forwarders of other users. On the other hand, freight forwards, railways or other companies, who offer such a freight service, can look for a freight opportunity in the system in the same way.
4. The application will be displayed by the example as follows:

4.1 User A enters the system through an URL (e.g. http://freight-service.xx). User A needs to be registered by entering all identification information, including its contact information (e.g. e-mail, mailing address, etc.).

4.2 User A receives an e-mail with a password confirmation.

4.3 User A enters the program by entering its user ID and password.

4.4 User A selects, if it is seeking or offering freight services.

4.5 User A selects the geographical departure point of the freight (e.g. from: North America/USA/New York).

4.6 User A selects the destination of the good (e.g. to: Europe/Italy/Bergamo).

4.7 User A selects the time and date of delivery (e.g. on: Oct. 24, 2007) or

4.8 User A selects a time frame for delivery (e.g. between Oct. 23, 2007 and Oct. 26, 2007).

4.9 User A may mark the type of goods to be transported (e.g. break bulk)

4.10 In order to avoid too restrictive research information, which might give only a few results, the user may enter an acceptable alternative route expressed in terms of chargeable mileage. Otherwise another user B, that is offering nearly the same freight service from New York to Milan (next to Bergamo) would not be informed of the search demand of user A. For example, user A may enter a maximum acceptable detour of 50 miles in order to cover other departure and destination points around New York and Bergamo.

4.11 User A will click the >search< button.

4.12 The program will generate a results list, where all other users appear that entered information that matches the search criteria of user A.

4.13 User A is able to contact one of the parties on the results list (e.g. by clicking on the e-mail address contained directly, or indirectly, by a link in this information).

4.14 Users A and B (matching users) may exchange further information (e.g. by phone)

4.15 If there is no matching user, user A may have the opportunity to click an icon indicating: “inform me of a future match” and will receive counterpart contact addresses (e.g. via e-mail) about all future matching users.
5. The system is comparable to advertisements in a newspaper. The difference to this is that the clearinghouse takes advantage of the internet by comparing and combining given data and by forwarding the results directly to the advertiser.

### EXAMPLE

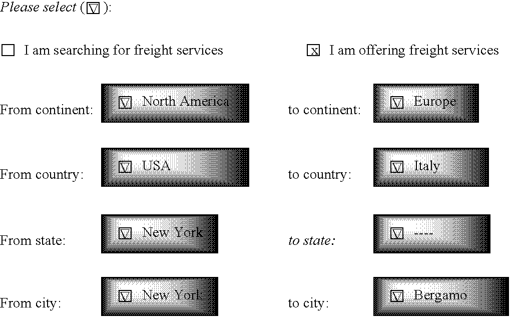

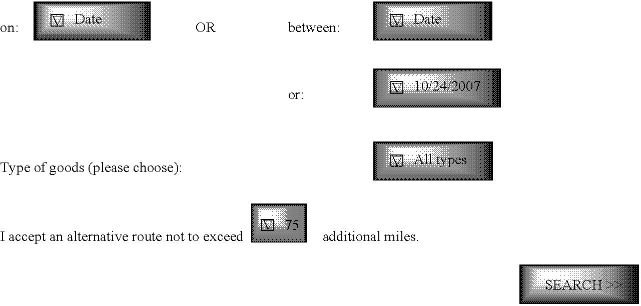

Table of Results (Sort by Prices):

| | |
|---|---|
| Request 325 Request date: 20/02/2007 | From: New York To: Milan |
| between: 10/23/2007 and 10/30/2007 | (+33 miles) |
| Type of good: bulk material | please contact: |
| | mrexample@milano.xx |
| | Quotation: USD 1,000 |
| Request 436 Request date: 19/04/2007 | From: New York To: Brescia |
| between: 10/20/2007 and 10/30/2007 | (+33 miles) |
| Type of good: break bulk | please contact: |
| | mrforwarder@example.xx |
| | Quotation: USD 1,150 |
| Request 10423 Request date: . . . | |

1. A method for administrating a dynamic advertising tool for freight services between transportation providers and customers (in the following called users) through a computer network, said business generally involving at least one system administrator, at least one person offering freight services and at least one person requiring freight service, who are accessible through a communication network, i.e. the internet; said method consists of the following elements: (1) a database storing and maintaining identifying information related to the users; said users having identified themselves by being registered with the system; and (2) providing a Web page including a search icon for accessing specific matching information from said database, after entering specific user information; (3) said program will search for its respective match and the data is added to the database for research purposes; (4) counterpart party, respectively either offering or inquiring into freight services and therefore representing a potential contracting party; (5) after clicking the search icon, the system will match all of the entered information to the data stored in the data base which will result in a results list.

2. The method of claim 1 enables the inquiring party to contact a prospective business associate; wherein the inquiring party may offer or inquire into the availability of freight services.

3. The method of claim 1 wherein said specific user information, comprises delivery schedule data of the departure and destination of the goods, the single and total volume of good(s), the single and total weight of good(s), the performance period, the date of the inquiry or offer was entered, the price of the service (the minimum price specified by the supplier and the maximum price specified by the potential customer), the type of goods, the maximum acceptable detour distance or maximum acceptable delay in time.

4. The method of claim 1 wherein said results list, contains the information specified by claim 3, and the contact information (e.g. phone, e-mail, facsimile or mailing address) of the prospective business associates.

5. The method of claim 2 wherein said parties contact each other, enables the users to negotiate further details of the potential business arrangement and possibly resulting in a contract.
